(19) United States
(12) Patent Application Publication
(10) Pub. No.: US 2025/0337611 A1
(43) Pub. Date: Oct. 30, 2025

(54) SWITCHING METHOD AND SWITCHING DEVICE OF SERIAL COMMUNICATION DEVICE, AND DIAGNOSTIC SYSTEM

(71) Applicant: Wuhu Tianma Automotive Electronics Co., Ltd., Wuhu (CN)

(72) Inventor: Liqin HAN, Wuhu (CN)

(21) Appl. No.: 18/933,302

(22) Filed: Oct. 31, 2024

(30) Foreign Application Priority Data
Apr. 28, 2024 (CN) 202410533977.3

(51) Int. Cl. H04L 12/40; H04L 12/403

(52) U.S. Cl. CPC H04L 12/40039; H04L 12/40032; H04L 12/403

(57) ABSTRACT

A switching method and a switching device of a serial communication device, and a diagnostic device are provided. The serial communication device includes a host and at least one slave connected to the host through a serial bus. The method is applied to a controller of the host and includes: when detecting a predetermined signal, releasing a control right of the serial bus, such that a target device acquires the control right and transmits data with the at least one slave. The predetermined signal includes at least one of a first signal and a second signal. The first signal is a signal indicating that the target device is connected to the serial communication device. The second signal is a signal indicating that the host is disconnected from the serial bus. The target device is a non-slave device connected to the serial bus.

### CROSS-REFERENCE TO RELATED APPLICATION

This application claims the priority of Chinese Patent Application No. 202410533977.3, filed on Apr. 28, 2024, the content of which is incorporated herein by reference in its entirety.

### TECHNICAL FIELD

The present disclosure generally relates to the field of electronic circuit technologies and, more particularly, relates to a switching method and device of a serial communication device, and a diagnostic system.

### BACKGROUND

Among existing communication interfaces between integrated circuits, the I2C (Inter-Integrated Circuit) bus is a widely used bus method. The I2C bus is a serial bus launched by PHLIPS. The I2C bus has only two bidirectional signal lines where one is the SDA data line and the other is the SCL clock line. In practical applications, the I2C bus only occupies two IO (Input/Output) pins and has a simple timing sequence. Therefore, most MCUs have built-in hardware I2C modules.

In an I2C system with multiple hosts and multiple slaves or multiple hosts and one slave, manual switching is required when switching between hosts, which is a cumbersome operation.

### SUMMARY

One aspect of the present disclosure provides a switching method of a serial communication device. The serial communication device includes a host and at least one slave connected to the host through a serial bus. The method is applied to a controller of the host and includes: when detecting a predetermined signal, releasing a control right of the serial bus, such that a target device acquires the control right and transmits data with the at least one slave. The predetermined signal includes at least one of a first signal and a second signal. The first signal is a signal indicating that the target device is connected to the serial communication device. The second signal is a signal indicating that the host is disconnected from the serial bus. The target device is a non-slave device connected to the serial bus.

Another aspect of the present disclosure provides a switching device of a serial communication device. The serial communication device includes a host and at least one slave connected to the host through a serial bus. The host includes a controller. The switching device includes: a release unit, configured to: when detecting a predetermined signal, release a control right of the serial bus, such that a target device acquires the control right and transmits data with the at least one slave. The predetermined signal includes at least one of a first signal and a second signal. The first signal is a signal indicating that the target device is connected to the serial communication device. The second signal is a signal indicating that the host is disconnected from the serial bus. The target device is a non-slave device connected to the serial bus.

Another aspect of the present disclosure provides a diagnostic system. The diagnostic system includes a printed circuit board and a diagnostic device. The printed circuit board includes a host and at least one slave. The host and the at least one slave are connected through a serial bus. The host includes a controller. The diagnostic device is connected to the serial bus of the printed circuit board, and is configured to acquire the control right of the serial bus and transmit data with the at least one slave of the printed circuit board to perform diagnostics on the at least one slave. The controller includes one or more processors, a memory, and one or more programs. The one or more programs are able to be executed by the one or more processors, to: when detecting a predetermined signal, release a control right of the serial bus, such that a diagnostic device acquires the control right and transmits data with the at least one slave. The predetermined signal includes at least one of a first signal and a second signal. The first signal is a signal indicating that the diagnostic device is connected to the serial communication device. The second signal is a signal indicating that the host is disconnected from the serial bus.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary mobile terminal for executing a switching method of a serial communication device, consistent with various disclosed embodiments of the present disclosure.

FIG. 2 illustrates an exemplary serial communication device, consistent with various disclosed embodiments of the present disclosure.

FIG. 3 illustrates an exemplary switching method of a serial communication device, consistent with various disclosed embodiments of the present disclosure.

FIG. 4 to FIG. 6 illustrate different structures of a serial communication device consistent with various disclosed embodiments of the present disclosure.

FIG. 7 to FIG. 9 illustrate different structures of another serial communication device consistent with various disclosed embodiments of the present disclosure.

FIG. 10 to FIG. 11 illustrate different structures of another serial communication device consistent with various disclosed embodiments of the present disclosure.

FIG. 12 illustrates an exemplary second switching device consistent with various disclosed embodiments of the present disclosure.

### DETAILED DESCRIPTION

Reference will now be made in detail to exemplary embodiments of the disclosure, which are illustrated in the accompanying drawings. Hereinafter, embodiments consistent with the disclosure will be described with reference to drawings. In the drawings, the shape and size may be exaggerated, distorted, or simplified for clarity. Wherever possible, the same reference numbers will be used throughout the drawings to refer to the same or like parts, and a detailed description thereof may be omitted.

Further, in the present disclosure, the disclosed embodiments and the features of the disclosed embodiments may be combined under conditions without conflicts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

Moreover, the present disclosure is described with reference to schematic diagrams. For the convenience of descriptions of the embodiments, the cross-sectional views illustrating the device structures may not follow the common proportion and may be partially exaggerated. Besides, those schematic diagrams are merely examples, and not intended to limit the scope of the disclosure. Furthermore, a three-dimensional (3D) size including length, width, and depth should be considered during practical fabrication.

As introduced in the background technology, the I2C bus switching operation between hosts in the existing technologies is relatively cumbersome. The present disclosure provides a switching method, device, computer-readable storage medium, printed circuit board and diagnostic system for serial communication devices.

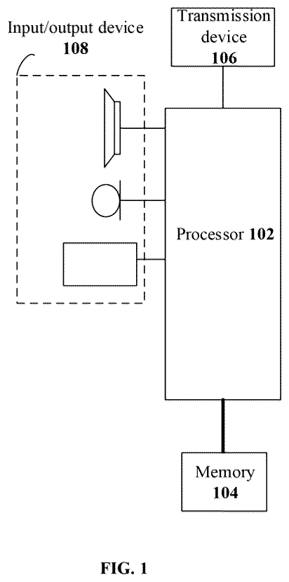

The switching method provided by the present disclosure may be executed in a mobile terminal, a computer terminal, or a similar computing device. One embodiment where the switching method is executed in a mobile terminal will be used as an example to illustrate the present disclosure. FIG. 1 is a hardware structure block diagram of a mobile terminal of a switching method for serial communication devices. As shown in FIG. 1, in one embodiment, the mobile terminal may include one or more processors 102 (the one or more processor 102 may include but is not limited to a processing device such as a microprocessor MCU or a programmable logic device FPGA, and only one processor is shown in FIG. 1) and a memory 104 for storing data. The mobile terminal may also include a transmission device 106 for communication functions and an input/output device 108. It can be understood by those skilled in the art that the structure shown in FIG. 1 is only for illustration and does not limit the structure of the mobile terminal. For example, in some other embodiments, the mobile terminal may also include more or fewer components than those shown in FIG. 1, or have a configuration different from that shown in FIG. 1.

The memory 104 may be used to store computer programs, for example, software programs or modules of application software, such as computer programs corresponding to the switching method of the serial communication devices provided by the present disclosure. The one or more processor 102 may execute various functional applications or data processing by running the computer programs stored in the memory 104, that is, the above method is implemented. The memory 104 may include a high-speed random access memory, and may also include a non-volatile memory, such as one or more magnetic storage devices, flash memory, or other non-volatile solid-state memory. In some examples, the memory 104 may further include a memory remotely arranged relative to the one or more processor 102, and the memory may be connected to the mobile terminal via a network. Examples of the network include but are not limited to the Internet, an intranet, a local area network, a mobile communication network, or a combination thereof. The transmission device 106 may be used to receive or send data via a network. The specific examples of the network may include a wireless network provided by a communication provider of the mobile terminal. In one example, the transmission device 106 may include a network adapter (Network Interface Controller, referred to as NIC), which may be connected to other network devices through a base station to communicate with the Internet. In one example, the transmission device 106 may be a radio frequency (RF) module for communicating with the Internet wirelessly.

The present disclosure provides a switching method of serial communication devices running on a mobile terminal, a computer terminal or a similar computing device. It should be noted that the steps shown in the flowchart of the accompanying drawings may be executed in a computer system such as a set of computer executable instructions, and although a logical order is shown in the flowchart, in some cases, the steps shown or described may be executed in a different order than that shown here.

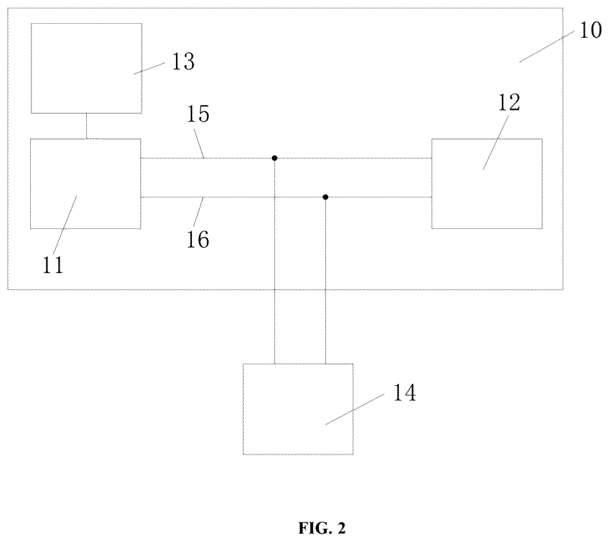

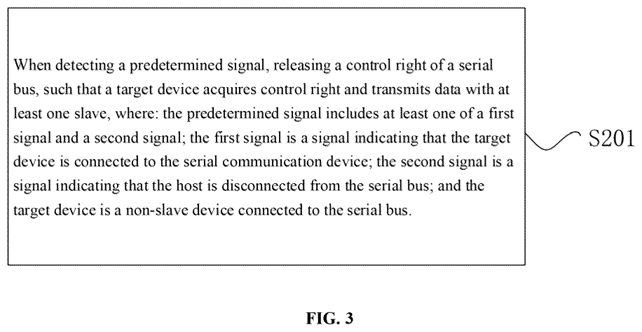

In one embodiment shown in FIG. 2, the serial communication device 10 may include a host 11 and at least one slave 12. The host 11 may be connected to the at least one slave 12 through a serial bus. The switching method of the serial communication device may be applied to a controller of the host 11. As shown in FIG. 3, the method may include S201 to S2011.

S201: when detecting a predetermined signal, the control right of the serial bus may be released, such that a target device 14 obtains the control right and transmits data with the at least one slave 12. The predetermined signal may include at least one of a first signal and or a second signal. The first signal may be a signal indicating that the target device 14 is connected to the serial communication device 10, and the second signal may be a signal indicating that the host 11 is disconnected from the serial bus. The target device 14 may be a non-slave device connected to the serial bus.

In one embodiment, after the controller of the host controls the host to release the control right of the serial bus, the target device may be connected to the serial bus as another host other than the host in the serial communication device. Therefore, the application scenario of the switching method of the serial communication device may be a multi-host multi-slave system or a multi-host one-slave system. The target device may be connected to the at least one slave through the serial bus to achieve connection to the serial communication device. The serial bus may be an I2C bus, an SPI (Serial Peripheral Interface) bus, an RS-232 bus, a UART (Universal Asynchronous Receiver/Transmitter) bus, or a USB (Universal Serial Bus) bus, etc.

In the present disclosure, when the controller of the host detects the first signal indicating that the target device is connected to the serial communication device, and/or when the controller detects the second signal indicating that the connection between the host and the serial bus is disconnected, the controller of the host may release the control right of the host to the serial bus, such that the target device takes over the control right and transmits data with the slave. The present disclosure may realize automatic switching between hosts, and solve the problem that manual switching is required when switching hosts in the existing technologies resulting in a relatively cumbersome switching operation.

In actual application, the target device may be a diagnostic test device of the serial communication device, which is used to perform diagnostic tests on the communication conditions of the slave in the serial communication device. Through the method, automatic diagnostic tests on the slave may be realized without powering off the serial communication device. Of course, the target device is not limited to the diagnostic device, and may also be devices for other purposes.

FIG. 2 exemplarily shows the connection relationship between the host 11, the slave 12 and the target device 14 when the serial bus is an I2C bus. As shown in FIG. 2, in one embodiment, the serial bus may include a data line 15 and a clock line 16. The host 11 may be connected to the slave 12 through the data line 15 and the clock line 16, respectively. Similarly, the target device 14 may be also connected to the slave 12 through the data line 15 and the clock line 16. When the host 11 releases the control right of the serial bus, the host 11 may be disconnected from the data line 15 and the clock line 16, respectively.

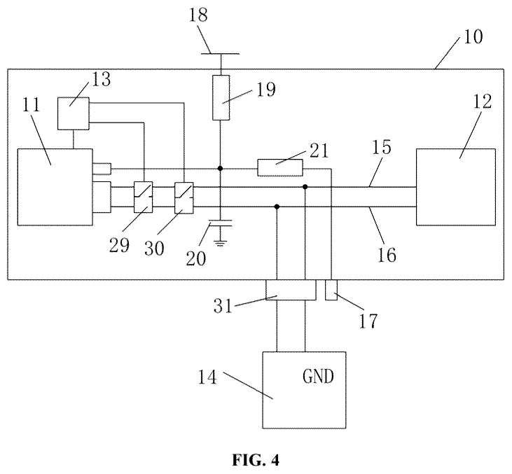

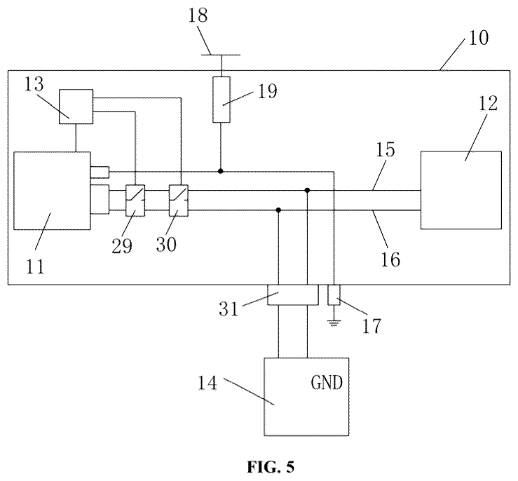

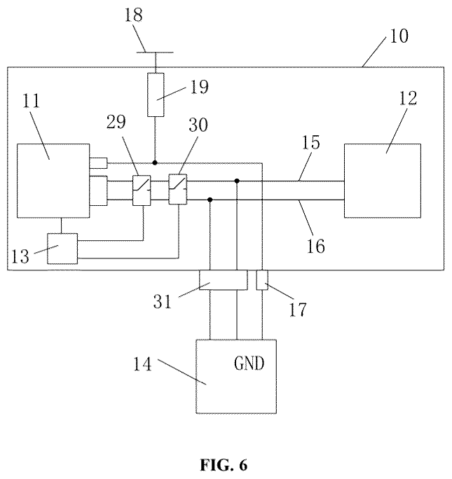

FIG. 4 to FIG. 6 exemplarily show a schematic structural diagram of a serial communication device 10 according to the present disclosure. As shown in FIG. 4 to FIG. 6, the host 11 may include a first port, and the serial communication device may further include a first external port 17 and a first trigger device. A first end of the first external port 17 may be used to connect to the outside of the serial communication device, and the first end of the first external port 17 may be in one of the following states: a suspended state as shown in FIG. 4 (i.e., a state in which the first end of the first external port 17 is not electrically connected to any device), a grounded state as shown in FIG. 5 (i.e., the first end of the first external port 17 is directly grounded), or a grounded state being electrically connected to the ground terminal GND of the target device 14 shown in FIG. 6 (i.e., the first end of the first external port 17 and the target device 14 share a ground terminal, and the first end of the first external port 17 is grounded through the target device 14). The first trigger device may include a first voltage divider device 19, a first end of the first voltage divider device 19 may be used to be electrically connected to a first power supply 18, and a second end of the first voltage divider device 19 may be electrically connected to the first port and the second end of the first external port 17, respectively. That is, the second end of the first external port 17 may be used to be electrically connected to the first port of the host in the serial communication device.

Based on the structures shown in FIG. 4 to FIG. 6, in S201, before releasing the control right of the serial bus when detecting the predetermined signal, the method may further include:

S202: detecting a voltage value of the first port, where the voltage value at the first port is the voltage value at the first external port, and is also the voltage value of the second end of the first voltage divider device; and

S203: when detecting that the voltage value of the first port is less than a first preset value, determining that the first signal is detected.

When the first end of the first external port is in the grounded state or is electrically connected to the ground end of the target device, the voltage value of the first port may be less than the first preset value. When the first end of the first external port is in the suspended state, the voltage value of the first port may be greater than or equal to the first preset value.

The first preset value may be determined according to the voltage of the first power supply and the resistance value of the first voltage divider device.

In the present embodiment, the voltage value of the first port may be the voltage

value at the second end of the first voltage divider device. When the first end of the first external port is in a suspended state, because of the pull-up effect of the first voltage divider device, the voltage value at the first port may be maintained at a voltage value larger than or equal to the first preset value, and the state at this time may be determined to be a state in which the target device is not connected to the serial communication device, that is, it may be determined that the first signal is not detected. When the first end of the first external port is in a grounded state or is electrically connected to the ground end of the target device, a loop from the first power supply, the first voltage divider device to the ground may be formed, and the voltage value at the first port may be reduced to a low level, such that the voltage value at the first port is less than the first preset value, and the state at this time may be determined to be a state in which the target device is connected to the serial communication device, that is, it may be determined that the first signal is detected.

In the present embodiment, the first voltage divider device and the first power supply may be connected between the first external port and the first port of the host, to implement the change of the voltage value of the first port by changing the connection state of the first end of the first external port. The controller of the host may determine whether the first signal representing the connection of the target device is triggered by detecting the voltage value of the first port. Through a simple structure and control method, automatic detection of whether the target device is connected to the serial communication device may be accurately achieved, thereby solving the problem that the host cannot automatically determine whether it needs to release control right and achieving the effect of automatically detecting whether there are other hosts connected to the serial bus. Therefore, the controller of the subsequent host may determine whether to actively release control rights based on the detection result, further solving the problem of the need to manually switch the control rights of the serial bus in the existing technologies, and ensuring the convenience of the switching process.

Optionally, the first voltage divider device may include only one resistor or multiple resistors connected in series or parallel.

In addition to the first voltage divider device, the first trigger device may also include a first light-emitting device, a first control switch or other structures. The first light-emitting device may be connected in series with the first voltage divider device, and the working state of the first voltage divider device may be indicated by the on and off state of the first light-emitting device. The first control switch may be connected in series with the first voltage divider device, and the user may control the connection state of the first voltage divider device and the first power supply by adjusting the switch state of the first control switch.

The first trigger device may also include a filter device and a current limiting device. In one embodiment, as shown in FIG. 4, the first voltage divider device 19 may include a pull-up resistor, and the first trigger device may also include a first filter device 20 and a first current limiting device 21. The first end of the first filter device 20 may be electrically connected to the second end of the first voltage divider device 19, and the second end of the first filter device 20 may be grounded. The second end of the first voltage divider device 19 may be electrically connected to the first external port 17 through the first current limiting device 21.

The first filter device may play a role of filtering and noise reduction, ensuring that the performance of the voltage signal at the first port is good. The first current limiting device may play a role of current limiting, ensuring the working safety of the first trigger device. In one embodiment, the first filter device may be a capacitor, an inductor, etc. The first current limiting device may be a resistor.

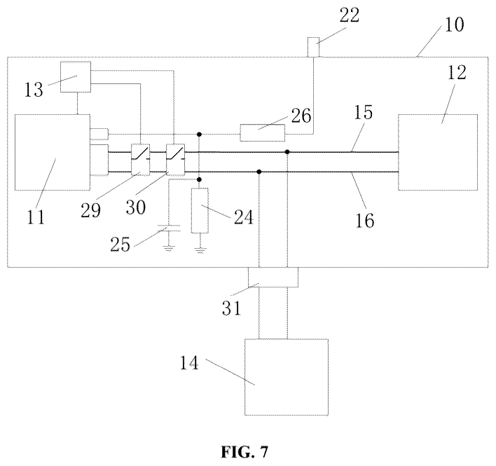

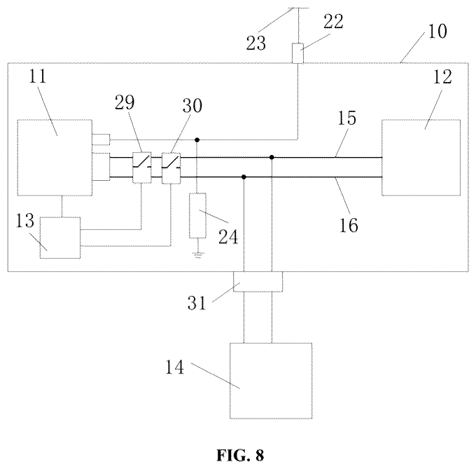

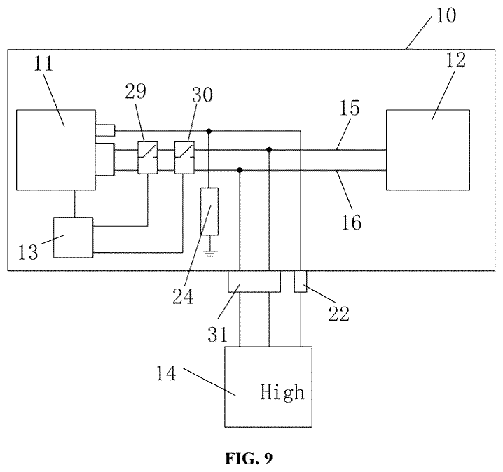

FIG. 7 to FIG. 9 exemplarily show a schematic structural diagram of another serial communication device according to the present disclosure. As shown in FIG. 7 to FIG. 9, in another embodiment, the host 11 may include a second port, the serial communication device may further include a second external port 22 and a second trigger device. A first end of the second external port 22 may be used to connect to the outside of the serial communication device. The second external port 22 may be in one of the following states: a suspended state as shown in FIG. 7 (i.e., the first end of the second external port 22 is not electrically connected to any device), a state electrically connected to the second power supply 23 as shown in FIG. 8 (i.e., the second external port receives a high level signal provided by the second power supply), and a state electrically connected to the high level output terminal High of the target device 14 as shown in FIG. 9 (i.e., the second external port receives a high level signal provided by the high level output terminal of the target device 14). The second trigger device may include a second voltage divider device 24. A first end of the second voltage divider device 24 may be grounded, and a second end of the second voltage divider device 24 may be electrically connected to the second port and the second end of the second external port 22, respectively. That is, the second end of the second external port 22 may be used to be electrically connected to the second port of the host 11 in the serial communication device.

Based on the structures shown in FIG. 7 to FIG. 9, in S201, before releasing the control right of the serial bus when detecting the predetermined signal, the method may further include:

S204: detecting a voltage value of the second port, where the voltage value at the second port is the voltage value at the second external port, and is also the voltage value of the second end of the second voltage divider; and

S205: when detecting that the voltage value of the second port is larger than a second preset value, determining that the first signal is detected.

When the first end of the second external port is in a state of being electrically connected to the second power supply or in a state of being electrically connected to the high-level output end of the target device, the voltage value of the second port may be larger than the second preset value. When the first end of the second external port is in the suspended state, the voltage value of the second port may be less than or equal to the second preset value.

In one embodiment, the second preset value may be determined according to one of the voltage of the second power supply and the voltage of the high-level output end and the resistance value of the second voltage divider.

In the present embodiment, the voltage value at the second port may be the voltage value at the second end of the second voltage divider. When the first end of the second external port is in the suspended state, because of the pull-down effect of the second voltage divider device, the voltage value at the second port may be maintained at a low level state less than or equal to the second preset value, and the state at this time may be determined to be a state in which the target device is not connected to the serial communication device, that is, it may be determined that the first signal is not detected. When the first end of the second external port is in a state in which it is electrically connected to the second power supply or to the high level output end of the target device, a current loop may be formed from the second power supply or the high level output end, the second voltage divider device to the ground. Because the current output by the second power supply or the high level output end is larger than the current of the second voltage divider device, the voltage value at the second port may be in a high level state, that is, the voltage value at the second port may be larger than the second preset value, and the state at this time may be determined to be a state in which the target device is connected to the serial communication device, that is, it may be determined that the first signal is detected.

In the present embodiment, the grounded second voltage divider device may be connected between the second external port and the second port of the host. Changes of the voltage value of the second port may be achieved by changing the connection state of the first end of the second external port. The controller of the host may determine whether the first signal representing the connection of the target device is triggered by detecting the voltage value of the second port. Through a simple structure and control method, automatic detection of whether the target device is connected to the serial communication device may be accurately achieved, thereby solving the problem that the host cannot automatically determine whether it needs to release control right and achieve the effect of automatically detecting whether there are other hosts connected to the serial bus. Therefore, the controller of the subsequent host may determine whether to actively release control rights based on the detection result, further solving the problem of the need to manually switch the control rights of the serial bus in the existing technologies, and ensuring the convenience of the switching process.

Optionally, the second voltage divider device may include only one resistor or multiple resistors connected in series or parallel.

In addition to the second voltage divider device, the second trigger device may also include a second light-emitting device, a second control switch and other structures. The second light-emitting device may be connected in series with the second voltage divider device, and indicate whether the second voltage divider device is connected to the second power supply or the high-level output terminal by the on-off state. The second control switch may be connected in series with the second voltage divider device, and the user may control the connection state between the second voltage divider device and the ground by adjusting the switch state of the second control switch.

The second trigger device may also include a filter device and a current limiting device. In one embodiment, as shown in FIG. 7, the second voltage divider device 24 may include a pull-down resistor, and the second trigger device may also include a second filter device 25 and a second current limiting device 26. A first end of the second filter device 25 may be electrically connected to the second end of the second voltage divider device 24, and a second end of the second filter device 25 may be grounded. The second end of the second voltage divider device 24 may be electrically connected to the second external port 22 through the second current limiting device 26.

The second filter device may play a role of filtering and noise reduction, ensuring that the performance of the voltage signal at the second port is good. The second current limiting device may play a role of current limiting, ensuring the working safety of the second trigger device.

In one embodiment, the second filter device may be a capacitor, an inductor, etc. The second current limiting device may be a resistor.

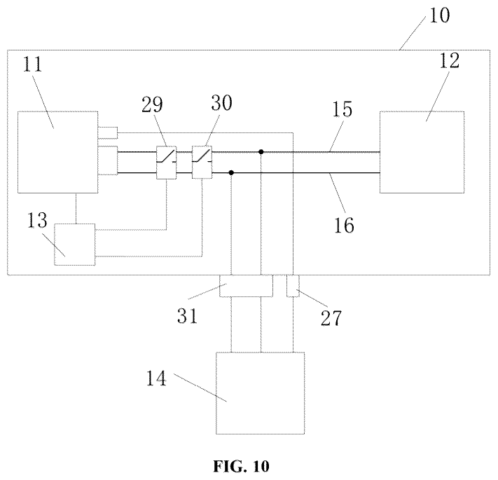

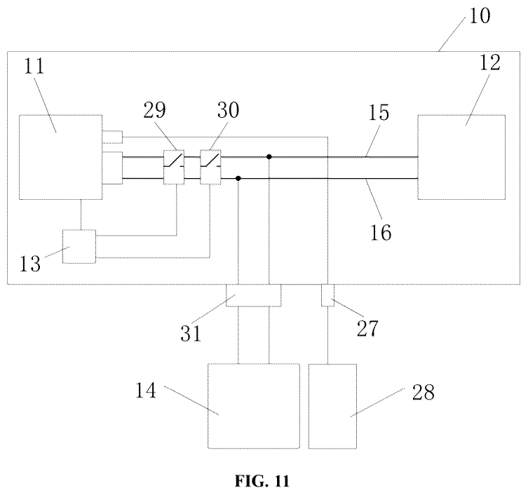

FIG. 10 and FIG. 11 exemplarily show a structural schematic diagram of another serial communication device according to the present disclosure. As shown in FIG. 10 and FIG. 11, in another embodiment, the serial communication device 10 may further include a third external port 27. A first end of the third external port 27 may be electrically connected to the target device 14 as shown in FIG. 10, or the first end of the third external port 27 may be electrically connected to a signal generator 28 as shown in FIG. 11, and a second end of the third external port 27 may be electrically connected to the host 11.

In S201, before releasing the control right of the serial bus when the predetermined signal is detected, the method may further include:

S206: determining whether the first signal sent by the target device or the signal generator is received.

In the above embodiment, the host may be connected to the target device or the signal generator through the third external port, and the target device or the signal generator may transmit the first signal to make the host aware that other hosts are connected to the serial bus, such that the host automatically releases the control right. Therefore, the automatic switching between hosts may be realized without modifying the structure of the serial communication device, which further ensures that the automatic switching between hosts is relatively simple.

The first signal may be any type of signal wave. According to some exemplary embodiments of the present disclosure, the first signal may include at least one of a square wave signal, a sine wave signal, a high level signal, or a low level signal.

In addition to the detection method of the first signal described in the above embodiments, in some other embodiments of the present disclosure, the second signal may also be automatically generated by the target device or the signal generator and sent to the host.

In some other embodiments, as shown in FIG. 4 to FIG. 11, the serial communication device may further include a first switching device 29, and the host 11 may include a third port. The third port may be connected to the serial bus through the first switching device 29.

The first switching device may be any suitable switching device in the existing technologies. For example, the first switching device may be a transistor such as a diode, an MOS tube, or a triode, or a mechanical switch, or an electrical controller such as a relay or an optocoupler.

The first switching device may include only one switching device to ensure that the overall structure of the device is relatively simple. In some other embodiments, the first switching device may also include a switch circuit composed of a plurality of switching devices to ensure the stability of the switch of the first switching device and avoid the problem of accidental touch.

In S201, before releasing the control right of the serial bus when the predetermined signal is detected, the method may further include:

S207: detecting the switch state of the first switching device, where when the switch state of the first switching device being disconnected indicates that the connection between the host and the serial bus is disconnected; and

S208: when it is detected that the switch state of the first switching device is in a disconnected state, determining that the second signal is detected.

In the present embodiment, by detecting the switch state of the first switching device between the host and the serial bus, it may be determined whether the second signal representing the disconnection of the host from the serial bus is detected, to determine whether to release the control right of the serial bus. Therefore, by controlling the switch state of the first switching device, the second signal may be triggered, such that the host automatically determines whether the control right needs to be released. The automatic switching between hosts without manual operation may be achieved, thereby liberating manpower.

The second signal of the present application may be any type of signal wave. According to some exemplary embodiments of the present disclosure, the second signal may include at least one of a square wave signal, a sine wave signal, a high level signal, or a low level signal.

The controller of the host may detect the switch state of the first switching device by a sensor detecting the voltage at both ends of the first switching device or detecting the current flowing through the first switching device, etc. For example, when the voltage at both ends of the first switching device is less than a third preset value, the switch state may be determined to be an open state. When the voltage at both ends of the first switching device is larger than or equal to the third preset value, the switch state may be determined to be a closed state. For another example, when the current flowing through the first switching device is less than a fourth preset value, the switch state may be determined to be an open state, and when the current flowing through the first switching device is larger than or equal to the fourth preset value, the switch state may be determined to be a closed state.

The method of detecting the switch state of the first switching device is used as an example only to illustrate the present disclosure, and is not used to limit the scope of the present disclosure. Those skilled in the art may also detect the switch state of the first switching device in other ways.

In some other embodiments as shown in FIG. 4 to FIG. 11, the serial communication device may further include a second switching device 30. The host 11 may be electrically connected to the serial bus through the second switching device 30.

The release unit may include: a first control module, configured to control the second switching device to disconnect when the predetermined signal is detected, to disconnect the connection between the host and the serial bus, such that the host releases the control right.

In the present embodiment, when the predetermined signal is detected, the connection between the host and the serial bus may be cut off by controlling the second switching device between the host and the serial bus, and the release control of the host control right may be realized through a simple structure and control method.

It should be noted that FIG. 4 to FIG. 11 only exemplarily show an embodiment in which the second switching device 30 is set outside the host 11. In actual application, the second switching device 30 is not limited to the setting method of being located outside the host 11. The second switching device 30 may also be integrated inside the host 11.

The second switching device may be any suitable switching device in the existing technologies. For example, the second switching device may be a transistor such as a MOS transistor or a triode. For another example, the second switching device may be an electrical controller such as a relay or an optocoupler.

The second switching device may include only one switch component to ensure that the overall structure of the device is relatively simple. In some other embodiments, the second switching device may also include a switch circuit composed of multiple switch components to ensure the stability of the switch of the second switching device and avoid the problem of false touch.

In one embodiment, the second switching device may be a transistor. In addition to a first end connected to the host and a second end connected to the serial bus, the second switching device may also include a control end, and the controller of the host may be electrically connected to the control end to control the one and off of the second switching device. In another embodiment, the second switching device may be a relay, the controller may realize the on or off of the contacts of the second switching device by controlling the input quantity of the second switching device. In yet another embodiment, the second switching device may be an optocoupler, and the controller may control the on or off of the light receiver of the second switching device by controlling the on or off of the light source of the second switching device.

In application, after the target device completes the data transmission with the slave, to further realize the automatic switching of the control right of the serial bus from the target device to the host, in one embodiment, the serial communication device may also include: a first acquisition unit, configured to reacquire the control right of the serial bus after releasing the control right of the serial bus and when the predetermined signal is not detected, that is, to control the host to reconnect the bus.

How the target device releases the control right may be to manually disconnect the connection between the target device and the serial bus, or to achieve the connection between the target device and the serial bus through software control. In one embodiment, the target device may include a controller, and the controller of the target device may be also used to run the device of the present disclosure.

In some embodiments, the serial communication device may also include: a second acquisition unit, configured to reacquire the control right of the serial bus after releasing the control right of the bus and when the duration of releasing the control right of the serial bus reaches a preset duration.

The first acquisition unit or the second acquisition unit may include: a second control module, configured to control the second switching device to be turned to establish a connection between the host and the serial bus, such that the host obtains the control right. In this embodiment, the switch state of the second switching device may be controlled to change from off to on, thereby realizing the electrical reconnection between the host and the serial bus.

FIG. 4 to FIG. 11 exemplarily show that the first switching device 29 is located on the side of the second switching device 30 close to the host 11. Of course, the positional relationship between the first switching device 29 and the second switching device 30 is not limited to that shown in the figure. In addition, FIG. 4 to FIG. 11 exemplarily show that the serial communication device 10 includes the first switching device 29 and the second switching device 30. In other exemplary embodiments, the first switching device 29 and the second switching device 30 may be combined into one switching device, that is, the serial communication device 10 may only include the first switching device 29 or the second switching device 30.

In another embodiment shown in FIG. 4 to FIG. 11, the serial communication device 10 may further include a fourth external port 31, and the target device 14 may be connected to the serial bus through the fourth external port 31.

In the present embodiment, the fourth external port may provide a port for connecting the serial bus of the serial communication device to an external target device. The target device may be connected to the serial bus in the serial communication device through the fourth external port, without opening the shell of the serial communication device, and without manually welding the target device and the serial bus. The serial communication device may be connected to the serial bus in the serial communication device through the fourth external port, further solving the problem of complicated diagnostic operation.

In one embodiment, the serial bus may be an I2C bus, and may include a data line and a clock line. The first switching device and the second switching device may both include a first sub-switch and a second sub-switch. The host may be connected to the data line through the first sub-switch, and the host may be connected to the clock line through the second sub-switch, thereby realizing the connection between the host and the serial bus. The fourth external port may include two sub-ports, where one sub-port is electrically connected to the data line, and the other sub-port is electrically connected to the clock line.

The switching device of the serial communication device may include a processor and a memory, and the release unit and the like may be stored in the memory as program units. The processor may execute the program units stored in the memory to realize the corresponding functions. The modules may be all located in the same processor; or, the modules may be located in different processors in the form of any combination.

The processor may include kernels, and the kernels may retrieve the corresponding program units from the memory. One or more kernels may be set, and by adjusting the kernel parameters, at least the problem of the cumbersome I2C bus switching operation between hosts in the existing technologies may be solved.

The memory may include a non-permanent memory in a computer-readable medium, a random access memory (RAM) and/or a non-volatile memory, such as read-only memory (ROM) or a flash RAM, and the memory may include at least one storage chip.

The present disclosure provides a computer-readable storage medium. A program may be stored in the computer-readable storage medium. When the program is running, a device where the computer-readable storage medium is located may be controlled to execute the switching method of the serial communication device provided by various embodiments of the present disclosure.

The present disclosure provides a processor. The processor may be used to execute a program, to implement the switching method of the serial communication device provided by various embodiments of the present disclosure.

The present disclosure provides a device. The device includes a processor, a memory, and a program stored in the memory and executable on the processor. The switching method of the serial communication device provided by various embodiments of the present disclosure may be implemented when the processor executes the program.

In various embodiments, the device may be a server, a PC, a PAD, a mobile phone, etc.

The present disclosure also provides a computer program product, which, when executed on a data processing device, is suitable for executing a program that initializes at least the steps of the switching method of the serial communication device provided by various embodiments of the present disclosure.

The present disclosure also provides a printed circuit board for implementing a serial communication device. In one embodiment, as shown in FIG. 4 to FIG. 11, the printed circuit board may include:

a host 11; and

at least one slave 12, where the host 11 and the at least one slave 12 may be connected through a serial bus.

The serial bus may be an I2C bus, an SPI bus, an RS-232 bus, a UART bus, or a USB, etc.

The controller 13 of the host 11 may include one or more processors, a memory, and one or more programs. The one or more programs may be stored in the above memory and configured to be executed by the above one or more processors to implement the switching method of the serial communication device provided by various embodiments of the present disclosure.

In the printed circuit board provided by the present disclosure, the controller of the host may control the host to release the control right of the serial bus when detecting the first signal representing the connection of the diagnostic device to the serial bus, and/or, when detecting the second signal representing the disconnection between the host and the serial bus, the control right of the host is released, such that the diagnostic device takes over the control right and transmits data with the slave. The present disclosure may realize the automatic switching between the host and the diagnostic device of the printed circuit board, and solve the problem that the switching between the host and the diagnostic device of the printed circuit board in the existing technologies requires manual switching causing the switching operation to be more cumbersome.

The controller may be an MCU (Micro Control Unit), a CPU (Central Processing Unit) or a PLC (Programmable Logic Controller), etc.

In one embodiment of the present disclosure, the target device may be used as a diagnostic device. As shown in FIG. 4 to FIG. 11, the diagnostic system may include: a printed circuit board and a diagnostic device.

The diagnostic device may be connected to a serial bus of the printed circuit board. The diagnostic device may be used to obtain the control right of the serial bus and transmit data with at least one slave of the printed circuit board to diagnose the slave.

Through the above embodiment, the diagnostic device may be electrically connected to the serial bus of the printed circuit board. When the diagnostic device is needed to diagnose the slave, the host controller in the printed circuit board may control the host to automatically release the connection to the serial bus, such that the diagnostic device takes over the control right of the serial bus to diagnose the slave. There may be no need to manually cut off the power supply of the printed circuit board and then switch the control right of the serial bus, which simplifies the slave diagnosis operation process and ensures the convenience of slave diagnosis.

In one embodiment as shown in FIG. 4 to FIG. 6, the host 11 of the printed circuit board may include a first port, and the printed circuit board may also include a first external port 17 and a first trigger device. The first end of the first external port 17 may be in one of the following states: a suspended state, a grounded state, and a state electrically connected to the ground terminal of the diagnostic device. The first trigger device may include a first voltage divider device 19, and the first end of the first voltage divider device 19 may be used to be electrically connected to a first power supply 18, and the second end of the first voltage divider device 19 may be electrically connected to the first port and the second end of the first external port 17, respectively.

In the present embodiment, when the first end of the first external port is in a suspended state, because of the pull-up effect of the first voltage divider device, the voltage value at the first port may be maintained at a high level; and when the first end of the first external port is in a grounded state or electrically connected to the ground end of the diagnostic device, a loop from the first power supply, the first voltage divider device to the ground may be formed, and the voltage value at the first port may be reduced to a low level. Therefore, by changing the connection state of the first end of the first external port, the voltage value of the first port may be changed. The controller of the host may determine whether the first signal representing the connection of the diagnostic device is triggered by detecting the voltage value of the first port. Through a simple structure and control method, it may be possible to accurately realize the automatic detection of whether the diagnostic device is connected to the printed circuit board, thereby solving the problem that the host cannot automatically determine whether the control right needs to be released.

Optionally, the first voltage divider device may include only one resistor, or multiple resistors connected in series and parallel.

In addition to the first voltage divider device, the first trigger device may also include a first light emitting device, a first control switch and other structures. The first light emitting device may be connected in series with the first voltage divider device, and the working state of the first voltage divider device may be indicated by the on and off state of the first light emitting device. The first control switch may be connected in series with the first voltage divider device, and the user may control the connection state of the first voltage divider device with the first power supply by adjusting the switch state of the first control switch.

The first trigger device may also include a filter device or a current limiting device. In one embodiment, as shown in FIG. 4, the first voltage divider device 19 may include a pull-up resistor, and the first trigger device may also include a first filter device 20 and a first current limiting device 21. The first end of the first filter device 20 may be electrically connected to the second end of the first voltage divider device 19, the second end of the first filter device 20 may be grounded, and the second end of the first voltage divider device 19 may be electrically connected to the first external port 17 through the first current limiting device 21.

The first filter device may play a role of filtering and noise reduction, ensuring that the performance of the voltage signal at the first port is good. The first current limiting device may play a role of current limiting, ensuring the working safety of the first trigger device. The first filter device may be a capacitor, an inductor, etc. The first current limiting device may be a resistor.

In another exemplary embodiment of the present disclosure, as shown in FIG. 7 to FIG. 9, the host 11 of the printed circuit board may include a second port, and the printed circuit board may also include a second external port 22 and a second trigger device. The first end of the second external port 22 may be in one of the following states: a suspended state, a state electrically connected to the second power supply 23, and a state electrically connected to the high-level output end of the diagnostic device. The second trigger device may include a second voltage divider device 24. The first end of the second voltage divider device 24 may be grounded, and the second end of the second voltage divider device 24 may be electrically connected to the second port and the second end of the second external port 22, respectively.

In the present embodiment, the voltage value at the second port may be the voltage value at the second end of the second voltage divider device. When the first end of the second external port is in the suspended state, because of the pull-down effect of the second voltage divider device, the voltage value at the second port may be maintained at a low level state less than or equal to the second preset value, and the state at this time may be determined to be a state in which the diagnostic device is not connected to the serial communication device, that is, it may be determined that the first signal is not detected. When the first end of the second external port is in a state in which it is electrically connected to the second power supply or to the high level output end of the diagnostic device, a current loop may be formed from the second power supply or the high level output end, the second voltage divider device to the ground. Because the current output by the second power supply or the high level output end is larger than the current of the second voltage divider device, the voltage value at the second port may be in a high level state, that is, the voltage value at the second port may be larger than the second preset value, and the state at this time may be determined to be a state in which the diagnostic device is connected to the serial communication device, that is, it may be determined that the first signal is detected.

In the present embodiment, the grounded second voltage divider device may be connected between the second external port and the second port of the host. Changes of the voltage value of the second port may be achieved by changing the connection state of the first end of the second external port. The controller of the host may determine whether the first signal representing the connection of the diagnostic device is triggered by detecting the voltage value of the second port. Through a simple structure and control method, automatic detection of whether the diagnostic device is connected to the serial communication device may be accurately achieved, thereby solving the problem that the host cannot automatically determine whether it needs to release control right and achieve the effect of automatically detecting whether there are other hosts connected to the serial bus. Therefore, the controller of the subsequent host may determine whether to actively release control rights based on the detection result, further solving the problem of the need to manually switch the control rights of the serial bus in the existing technologies, and ensuring the convenience of the switching process.

Optionally, the second voltage divider device may include only one resistor or multiple resistors connected in series or parallel.

In addition to the second voltage divider device, the second trigger device may also include a second light-emitting device, a second control switch and other structures. The second light-emitting device may be connected in series with the second voltage divider device, and indicate whether the second voltage divider device is connected to the second power supply or the high-level output terminal by the on-off state. The second control switch may be connected in series with the second voltage divider device, and the user may control the connection state between the second voltage divider device and the ground by adjusting the switch state of the second control switch.

The second trigger device may also include a filter device and a current limiting device. In one embodiment, as shown in FIG. 7, the second voltage divider device 24 may include a pull-down resistor, and the second trigger device may also include a second filter device 25 and a second current limiting device 26. A first end of the second filter device 25 may be electrically connected to the second end of the second voltage divider device 24, and a second end of the second filter device 25 may be grounded. The second end of the second voltage divider device 24 may be electrically connected to the second external port 22 through the second current limiting device 26.

The second filter device may play a role of filtering and noise reduction, ensuring that the performance of the voltage signal at the second port is good. The second current limiting device may play a role of current limiting, ensuring the working safety of the second trigger device.

In one embodiment, the second filter device may be a capacitor, an inductor, etc. The second current limiting device may be a resistor.

As shown in FIG. 10 and FIG. 11, in another embodiment, the printed circuit board may further include a third external port 27. A first end of the third external port 27 may be electrically connected to the diagnostic device, or the first end of the third external port 27 may be electrically connected to a signal generator 28 as shown in FIG. 11, and a second end of the third external port 27 may be electrically connected to the host 11. The diagnostic device or the signal generator 28 may be configured to generate the first signal or the second signal.

In the above embodiment, the host may be connected to the diagnostic device or the signal generator through the third external port, and the diagnostic device or the signal generator may transmit the predetermined signal to make the host aware that other hosts are connected to the serial bus, such that the host automatically releases the control right. Therefore, the automatic switching between the host and the diagnostic device may be realized without modifying the structure of the printed circuit board, which further ensures that the automatic switching between hosts is relatively simple.

In another embodiment, as shown in FIG. 4 to FIG. 11, the printed circuit board may further include a fourth external port 31, and the diagnostic device may be connected to the serial bus via the fourth external port 31.

The fourth external port may provide a port for connecting the serial bus of the printed circuit board with an external diagnostic device, and the diagnostic device may be connected to the serial bus in the printed circuit board via the fourth external port, without opening the housing of the printed circuit board or manually soldering the connection between the diagnostic device and the serial bus, and the diagnostic device may be connected to the serial bus in the printed circuit board via the fourth external port, further solving the problem of complicated diagnostic operation.

In some other embodiments, as shown in FIG. 4 to FIG. 11, the printed circuit board may further include a first switching device 29, and the host 11 may include a third port. The third port may be connected to the serial bus through the first switching device 29. The switch state of the first switching device 29 may directly reflect the connection state between the host and the serial bus.

The first switching device may be any suitable switching device in the existing technologies. For example, the first switching device may be a transistor such as a diode, an MOS tube, or a triode, or a mechanical switch, or an electrical coupler such as a relay or an optocoupler.

The first switching device may include only one switching device to ensure that the overall structure of the device is relatively simple. In some other embodiments, the first switching device may also include a switch circuit composed of a plurality of switching devices to ensure the stability of the switch of the first switching device and avoid the problem of accidental touch.

The first switching device may include a mechanical switch, and the control end of the mechanical switch may be located on the packaging shell of the printed circuit board. The mechanical switch may be disposed on the packaging shell of the printed circuit board to facilitate the user to close or open the first switching device, thereby changing the switch state of the first switching device and controlling whether to trigger the second signal representing the disconnection of the host from the serial bus.

In some other embodiments as shown in FIG. 4 to FIG. 11, the printed circuit board may further include a second switching device 30. The host 11 may be electrically connected to the serial bus through the second switching device 30. The controller of the host 11 may be used to control the switch state of the second switching device 30.

When the predetermined signal is detected, the connection between the host and the serial bus may be cut off by controlling the second switching device between the host and the serial bus, and the release control of the host control right may be realized through a simple structure and control method.

The second switching device may be any suitable switching device in the existing technologies. For example, the second switching device may be a transistor such as a MOS transistor or a triode. For another example, the second switching device may be an electrical controller such as a relay or an optocoupler.

The second switching device may include only one switch component to ensure that the overall structure of the device is relatively simple. In some other embodiments, the second switching device may also include a switch circuit composed of multiple switch components to ensure the stability of the switch of the second switching device and avoid the problem of false touch.

In one embodiment, the second switching device may be a transistor. In addition to a first end connected to the host and a second end connected to the serial bus, the second switching device may also include a control end, and the controller of the host may be electrically connected to the control end to control the one and off of the second switching device. In another embodiment, the second switching device may be a relay, the controller may realize the on or off of the contacts of the second switching device by controlling the input quantity of the second switching device. In yet another embodiment, the second switching device may be an optocoupler, and the controller may control the on or off of the light receiver of the second switching device by controlling the on or off of the light source of the second switching device.

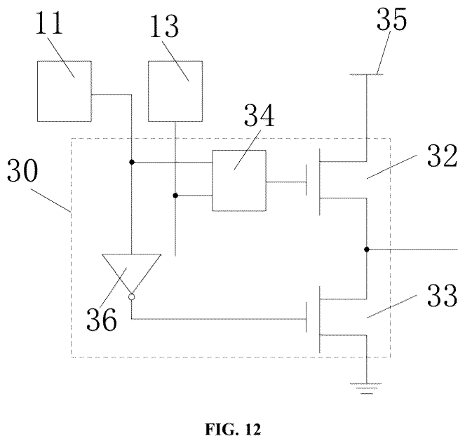

In one embodiment of the present disclosure as shown in FIG. 12, the second switching device 30 may include a first sub-transistor 32 and a second sub-transistor 33. The second switching device 30 may also include an AND gate 34 and a NOT gate 36. The first sub-transistor 32 and the second sub-transistor 33 may have the same conduction type, that is, they may be both P-type transistors or both N-type transistors. The first end of the first sub-transistor 32 may be used to be electrically connected to the third power supply 35. The second end of the first sub-transistor 32 may be electrically connected to the first end of the second sub-transistor 33. The second end of the second sub-transistor 33 may be grounded. The control end of the first sub-transistor 32 may be electrically connected to the output end of the AND gate 34. The first input end of the AND gate 34 may be electrically connected to the controller 13 of the host 11. The second input end of the AND gate 34 may be electrically connected to the input end of the NOT gate 36. The output end of the NOT gate 36 may be electrically connected to the control end of the second sub-transistor 33. The third port of the host may be electrically connected to the second input end of the AND gate 34. The serial bus may be electrically connected to the first end of the second sub-transistor 33. The first sub-transistor 32, the second sub-transistor 33 and the NOT gate 36 may form a push-pull transistor.

In a control process, when it is necessary to control the second switching device to be disconnected, the controller of the host may control the host to send data to the serial bus. When the data passes through the second switching device, the second sub-transistor may be disconnected (when the data sent by the host is high-level data, the second sub-transistor is an N-type transistor; when the data sent by the host is low-level data, the second sub-transistor is a P-type transistor). The controller may control the level of the input to the first input terminal of the AND gate, such that the second sub-transistor is also disconnected, and the host is disconnected from the serial bus.

The modules or steps of the present disclosure described above can be implemented by a general-purpose computing device, they can be concentrated on a single computing device, or distributed on a network composed of multiple computing devices, they can be implemented by a program code executable by a computing device, so that they can be stored in a storage device and executed by the computing device, and in some cases, the steps shown or described can be executed in a different order from that here, or they can be made into individual integrated circuit modules, or multiple modules or steps therein can be made into a single integrated circuit module for implementation. In this way, the present disclosure is not limited to any specific combination of hardware and software.

It should be understood by those skilled in the art that the embodiments of the present disclosure can be provided as a method, system, or computer program product.

Therefore, the present disclosure can take the form of a complete hardware embodiment, a complete software embodiment, or an embodiment combining software and hardware. Moreover, the present disclosure can take the form of a computer program product implemented on one or more computer-usable storage media (including but not limited to disk storage, CD-ROM, optical storage, etc.) containing computer-usable program codes.

The present disclosure is described with reference to the flowcharts and/or block diagrams of the methods, devices (systems), and computer program products according to the embodiments of the present disclosure. It should be understood that each process and/or box in the flowchart and/or block diagram, as well as the combination of processes and/or boxes in the flowchart and/or block diagram, can be implemented by computer program instructions. These computer program instructions can be provided to a processor of a general-purpose computer, a special-purpose computer, an embedded processor, or other programmable data processing device to produce a machine, so that the instructions executed by the processor of the computer or other programmable data processing device produce a device for implementing the functions specified in one or more processes in the flowchart and/or one or more boxes in the block diagram.

These computer program instructions can also be stored in a computer-readable memory that can guide a computer or other programmable data processing device to work in a specific manner, so that the instructions stored in the computer-readable memory produce a product including an instruction device, which implements the functions specified in one or more processes in the flowchart and/or one or more boxes in the block diagram.

These computer program instructions can also be loaded onto a computer or other programmable data processing device, so that a series of operating steps are performed on the computer or other programmable device to produce a computer-implemented process, so that the instructions executed on the computer or other programmable device provide steps for implementing the functions specified in one or more processes in the flowchart and/or one or more boxes in the block diagram.

In a typical configuration, a computing device includes one or more processors (CPU), input/output interfaces, network interfaces, and a memory. The memory may include non-permanent memory in a computer-readable medium, random access memory (RAM) and/or non-volatile memory in the form of read-only memory (ROM) or flash RAM. Memory is an example of a computer-readable medium. The computer-readable medium may include permanent and non-permanent, removable and non-removable media that can be implemented by any method or technology to store information. Information can be computer-readable instructions, data structures, modules of programs, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digital versatile disk (DVD) or other optical storage, magnetic cassettes, tape disk storage or other magnetic storage devices or any other non-transmission media that can be used to store information that can be accessed by a computing device. According to the definition in this article, computer-readable media does not include temporary computer-readable media (transitory media), such as modulated data signals and carrier waves.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure, which is determined by the appended claims.

What is claimed is:

1. A switching method for a serial communication device, the serial communication device including a host and at least one slave connected to the host through a serial bus, the method being applied to a controller of the host and comprising:
when detecting a predetermined signal, releasing a control right of the serial bus, such that a target device acquires the control right and transmits data with the at least one slave, wherein:
the predetermined signal includes at least one of a first signal and a second signal;
the first signal is a signal indicating that the target device is connected to the serial communication device;
the second signal is a signal indicating that the host is disconnected from the serial bus; and
the target device is a non-slave device connected to the serial bus.

2. The method according to claim 1, wherein:
the host includes a first port;
the serial communication device also includes a first external port and a first trigger device;
a first end of the first external port is in one of a suspended state, a grounded state, or a state electrically connected to a ground end of the target device;
the first trigger device includes a first voltage divider device, wherein a first end of the first voltage divider device is electrically connected to a first power supply and a second end of the first voltage divider device is electrically connected to the first port and a second end of the first external port respectively; and
before releasing the control right of the serial bus when the predetermined signal is detected, the method further includes:
detecting a voltage value of the first port; and
when it is detected that the voltage value of the first port is smaller than a first preset value, determining that the first signal is detected, wherein: the voltage value of the first port is smaller than the first preset value when the first end of the first external port is in the grounded state or in the state electrically connected to the ground end of the target device, and the voltage value of the first port is larger than or equal to the first preset value when the first end of the first external port is in the suspended state.

3. The method according to claim 1, wherein:
the host includes a second port;
the serial communication device further includes a second external port and a second trigger device;
a first end of the second external port is in one of a suspended state, a state electrically connected to a second power supply, or a state electrically connected to a high-level output end of the target device;
the second trigger device includes a second voltage divider, wherein a first end of the second voltage divider is grounded and a second end of the second voltage divider is electrically connected to the second port and a second end of the second external port respectively; and
before releasing the control right of the serial bus when detecting the predetermined signal, the method further includes:
detecting a voltage value of the second port;
when detecting that the voltage value of the second port is larger than a second preset value, determining that the first signal is detected, wherein: the voltage value of the second port is larger than the second preset value when the first end of the second external port is in the state of being electrically connected to the second power supply or being electrically connected to the high-level output end of the target device, and the voltage value of the second port is smaller than or equal to the second preset value when the first end of the second external port is in the suspended state.

4. The method according to claim 1, wherein:
the serial communication device also includes a third external port;
a first end of the third external port is electrically connected to the target device or is electrically connected to a signal generator, and a second end of the third external port is electrically connected to the host; and
before releasing the control right of the serial bus when detecting the predetermined signal, the method further includes: determining whether the first signal sent by the target device or the signal generator is received.

5. The method according to claim 4, wherein:
the first signal includes at least one of a square wave signal, a sine wave signal, a high-level signal, or a low-level signal.

6. The method according to claim 1, wherein:
the host includes a third port connected to the serial bus through a first switching device; and
before releasing the control right of the serial bus when detecting the predetermined signal, the method further includes: detecting a switch state of the first switching device; and
when it is detected that the switch state is a disconnected state, determining that the second signal is detected.

7. The method according to claim 1, wherein:
the serial communication device further includes a second switching device;
the host is connected to the serial bus through the second switching device; and
releasing the control right of the serial bus when detecting the predetermined signal includes: when the predetermined signal is detected, controlling the second switching device to disconnect, to disconnect the connection between the host and the serial bus, such that the host releases the control right.

8. The method according to claim 7, after releasing the control right of the serial bus, further including:
when the predetermined signal is not detected, regaining the control right of the serial bus.

9. The method according to claim 8, wherein regaining the control right of the serial bus includes:
controlling the second switching device to close to establish a connection between the host and the serial bus, such that the host obtains the control right.

10. A switching device of a serial communication device, the serial communication device including a host and at least one slave connected to the host through a serial bus, the switching device being applied to a controller of the host and comprising:
a release unit, configured to: when detecting a predetermined signal, release a control right of the serial bus, such that a target device acquires the control right and transmits data with the at least one slave,
wherein:
the predetermined signal includes at least one of a first signal and a second signal;
the first signal is a signal indicating that the target device is connected to the serial communication device;
the second signal is a signal indicating that the host is disconnected from the serial bus; and
the target device is a non-slave device connected to the serial bus.

11. A diagnostic system, comprising:
a printed circuit board including a host and at least one slave; and
a diagnostic device,
wherein:
the host and the at least one slave are connected through a serial bus;
the host includes a controller;
the diagnostic device is connected to the serial bus of the printed circuit board, and is configured to acquire the control right of the serial bus and transmit data with the at least one slave of the printed circuit board to perform diagnostics on the at least one slave;
the controller includes one or more processors, a memory, and one or more programs;
the one or more programs are able to be executed by the one or more processors, to: when detecting a predetermined signal, release a control right of the serial bus, such that the diagnostic device acquires the control right and transmits data with the at least one slave, wherein:
the predetermined signal includes at least one of a first signal and a second signal;
the first signal is a signal indicating that the diagnostic device is connected to the serial communication device;
the second signal is a signal indicating that the host is disconnected from the serial bus.

12. The diagnostic system according to claim 11, wherein:
the host of the printed circuit board includes a first port;
the printed circuit board also includes a first external port and a first trigger device;
a first end of the first external port is in one of a suspended state, a grounded state, or a state electrically connected to a ground end of the diagnostic device; and
the first trigger device includes a first voltage divider device, wherein: a first end of the first voltage divider device is electrically connected to a first power supply, and a second end of the first voltage divider device is electrically connected to the first port and a second end of the first external port respectively.

13. The diagnostic system according to claim 12, wherein:
the first voltage divider device includes a pull-up resistor;
the first trigger device also includes a first filter device and a first current limiting device;
a first end of the first filter device is electrically connected to the second end of the first voltage divider device;
a second end of the first filter device is grounded; and
the second end of the first voltage divider device is electrically connected to the first external port through the first current limiting device.

14. The method according to claim 11, wherein:
the host of the printed circuit board includes a second port;
the printed circuit board further includes a second external port and a second trigger device;
a first end of the second external port is in one of a suspended state, a state electrically connected to a second power supply, or a state electrically connected to a high-level output end of the diagnostic device; and
the second trigger device includes a second voltage divider device, wherein a first end of the second voltage divider device is grounded and a second end of the second voltage divider device is electrically connected to the second port and a second end of the second external port respectively.

15. The diagnostic system according to claim 13, wherein:
the second voltage divider device includes a pull-down resistor.

16. The diagnostic system according to claim 11, wherein:
the printed circuit board also includes a third external port;
a first end of the third external port is electrically connected to the diagnostic device or is electrically connected to a signal generator, and a second end of the third external port is electrically connected to the host.

17. The diagnostic system according to claim 11, wherein:
the printed circuit board also includes a fourth external port, and the diagnostic device is connected to the serial bus through the fourth external port.

18. The diagnostic system according to claim 11, wherein:
the host includes a third port connected to the serial bus through a first switching device; and
the first switching device includes a mechanical switch, and a control end of the mechanical switch is located on a packaging housing of the printed circuit board.

19. The diagnostic system according to claim 11, wherein:
the serial communication device further includes a second switching device; and
the host is connected to the serial bus through the second switching device.

20. The diagnostic system according to claim 19, wherein:
the second switching device includes a push-pull pair of transistors.
